(19) United States
(12) Patent Application Publication
(10) Pub. No.: US 2020/0406711 A1
(43) Pub. Date: Dec. 31, 2020

(54) FLOW CONTROL VALVE

(71) Applicant: GM Global Technology Operations LLC, Detroit, MI (US)

(72) Inventors: Daniele Di Martino, Turin (IT); Giuseppe D'Aurizio, Lanciano (IT); Riccardo Franz Turcato, Montalto Dora (IT); Tiberiu Vasilcin, Torino (IT)

(21) Appl. No.: 16/456,997

(22) Filed: Jun. 28, 2019

(51) Int. Cl. B60H 1/00; F16K 17/10; F16K 27/02

(52) U.S. Cl. CPC B60H 1/00885; F16K 27/02; F16K 17/105

(57) ABSTRACT

A flow control valve for coolant flow in a motor vehicle includes a body, a first base plate positioned on a first end of the body, and a second base plate positioned on a second end of the body. The body has a main opening and a secondary opening to control the coolant flow.

The present disclosure relates to coolant systems for motor vehicles. More specifically, the present disclosure relates to a control valve for coolant systems.

Many motor vehicles include an internal combustion engine as a power plant. Typically, a coolant system is utilized to circulate coolant through and about portions of the engine to ensure that the engine does not overheat. As the engine speed increases, the amount of coolant circulated through the engine increases. In some coolant systems, however, more than necessary coolant flow is circulated through the engine at lower engine speeds.

Thus, while current coolant systems achieve their intended purpose, there is a need for a new and improved system that reduces the coolant flow to the minimum required to maintain optimum efficiency of the engine.

### SUMMARY

According to several aspects, a flow control valve for coolant flow in a motor vehicle includes a body, a first base plate positioned on a first end of the body, and a second base plate positioned on a second end of the body. The body has a main opening and a secondary opening to control the coolant flow.

In an additional aspect of the present disclosure, the main opening and the secondary opening define a T-shaped opening.

In another aspect of the present disclosure, the secondary opening is a U-shaped opening.

In another aspect of the present disclosure, the coolant flow with the secondary opening is less than the coolant flow without the secondary opening.

In another aspect of the present disclosure, the flow control valve further includes a spring that provides a biasing force on an actuator positioned in the body.

In another aspect of the present disclosure, the flow control valve is coupled to a DC motor through a set of gears.

In another aspect of the present disclosure, the coolant flow with the spring is less than the coolant flow without the spring.

In another aspect of the present disclosure, the flow control valve is calibrated such that an open-to-close prolife and a close-to-open profile begin and end with the same coolant flow.

In another aspect of the present disclosure, the coolant flow with the calibrated flow control valve is less than the coolant flow without calibration.

According to several aspects, a flow control valve for coolant flow in a motor vehicle includes a body, a first base plate positioned on a first end of the body, and a second base plate positioned on a second end of the body. The body has a main opening and a secondary opening to control the coolant flow, the main opening and the secondary opening defining a T-shaped opening, the secondary opening being a U-shaped opening.

In another aspect of the present disclosure, the coolant flow with the secondary opening is less than the coolant flow without the secondary opening.

In another aspect of the present disclosure, the flow control valve further includes a spring that provides a biasing force on an actuator positioned in the body.

In another aspect of the present disclosure, the flow control valve is coupled to a DC motor through a set of gears.

In another aspect of the present disclosure, the coolant flow with the spring is less than the coolant flow without the spring.

In another aspect of the present disclosure, the flow control valve is calibrated such that an open-to-close prolife and a close-to-open profile begin and end with the same coolant flow.

In another aspect of the present disclosure, the coolant flow with the calibrated flow control valve is less than the coolant flow without calibration.

According to several aspects, a flow control valve for coolant flow in a motor vehicle includes a body, a first base plate positioned on a first end of the body, a second base plate positioned on a second end of the body, the body having a main opening and a secondary opening to control the coolant flow; and a spring that provides a biasing force on an actuator positioned in the body. The coolant flow with the spring is less than the coolant flow without the spring.

In another aspect of the present disclosure, the flow control valve is calibrated such that an open-to-close prolife and a close-to-open profile begin and end with the same coolant flow.

In another aspect of the present disclosure, the coolant flow with the calibrated flow control valve is less than the coolant flow without calibration.

In another aspect of the present disclosure, the main opening and the secondary opening define a T-shaped opening, the secondary opening has a U-shaped opening, and the coolant flow with the secondary opening is less than the coolant flow without the secondary opening.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side view of a flow control valve according to an exemplary embodiment;

FIG. 2A is a perspective view of a portion of a coolant system implementing the flow control valve is according to an exemplary embodiment;

FIG. 2B is a side view of the coolant system shown in FIG. 2B;

FIG. 3 is a graph of a percentage of coolant flow (ϕ) versus a position (Δ) of an actuator for various flow control valves;

FIG. 4A is a graph of the percentage of coolant flow (ϕ) versus the position (Δ) of an actuator in the flow control valve shown in FIG. 1, illustrating the effects of an inner spring associated with the actuator; and

FIG. 4B is a side cross-sectional view of the flow control valve shown in FIG. 1;

FIG. 4C is a side interior view of the flow control valve shown in FIG. 1; and

FIG. 5 is a graph of the percentage of coolant flow (ϕ) versus the position (Δ) of the actuator in the flow control valve shown in FIG. 1 when calibrated for zero flow.

### DETAILED DESCRIPTION

The following description is merely exemplary in nature and is not intended to limit the present disclosure, application, or uses.

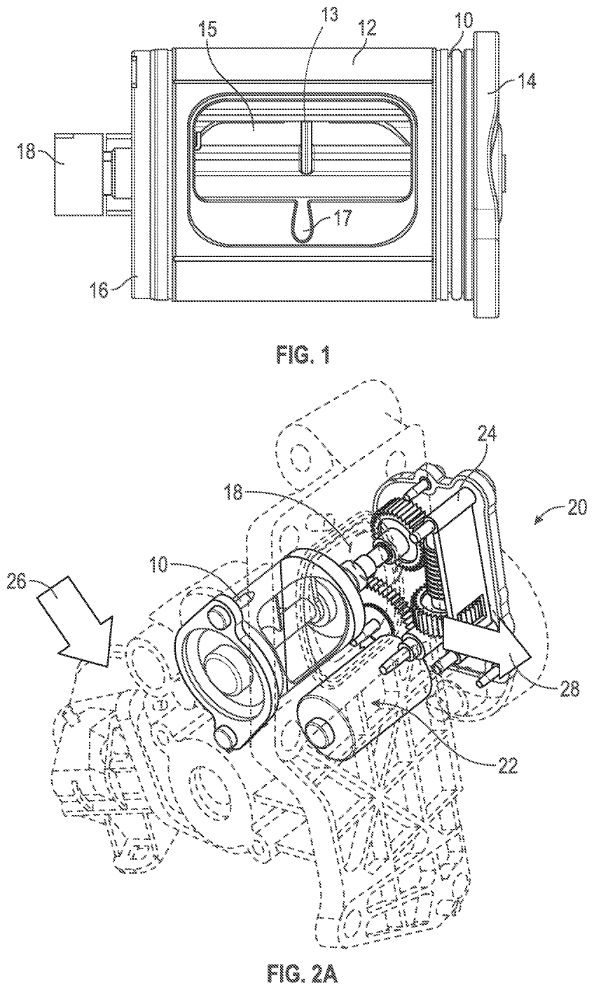

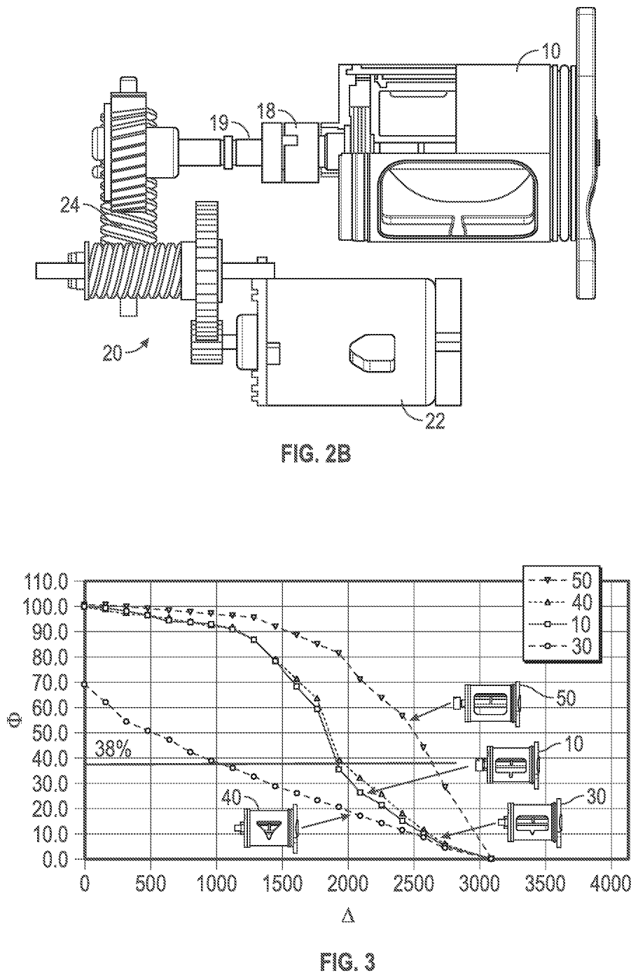

Referring to FIGS. 1, 2A and 2B, there is shown a flow control valve 10 for a portion of a coolant system 20 that provides coolant for a motor vehicle internal combustion engine according to the principles of the present disclosure. The flow control valve 10 includes a housing or body 12 and a first end plate 14 and a second end plate 16 positioned at the respective ends of the body 12. An actuator 13 is situated in the body 12. The actuator 13 is attached to a coupler 18 such that rotation of the coupler 18 rotates the actuator 13 within the body 12. Coolant flows into the flow control valve 10, as indicated by the arrow 26, and flows out of the flow control valve 10 through an opening 15, as indicated by the arrow 28.

The coupler 18 that engages with a joint 19 associated with a set of gears 24. Accordingly, rotational energy from a DC motor 22 is transmitted via the set of gears 24 to the flow control valve 10 through the engagement between the joint 19 and the coupler 18. Specifically, rotational energy from the DC motor rotates the actuator 13 located within the body 12.

Note further that the flow control valve 10 has a secondary opening 17 that has, generally, a U-shape. As such, the opening 15 and the secondary opening 17 define a T-shape opening.

Turning now to FIG. 3, there is shown a graph of percentage of coolant flow (ϕ) versus the position (Δ) of the actuator 13 for the flow control valve 10 as compared to other flow control valves 30, 40 and 50. The flow control valve 50 has no secondary opening, the flow control valve 30 is an alternative flow control valve according to the principles of the present disclosure and has a V-shape secondary opening, and the flow control valve 40 has a V-shape primary opening. As indicated in FIG. 3, the coolant flow through the flow control valves 10 and 30 are below that of the flow control valve 50 and above that of the flow control valve 40. For coolant flow below a threshold, for example, 38% of maximum flow, both the flow control valves 10 and 30 have a linear flow response from 0 to 38%. Accordingly, both control valves 10 and 30 reduce flow variations for small angular position changes of the actuator 13 unlike the flow control valve 50. Both control valves 10 and 30 also provide a smooth transition from the 38% threshold to maximum flow (about 90%) for overpressure control at high engine speeds. Whereas the flow control valve 40 is incapable of providing full coolant flow.

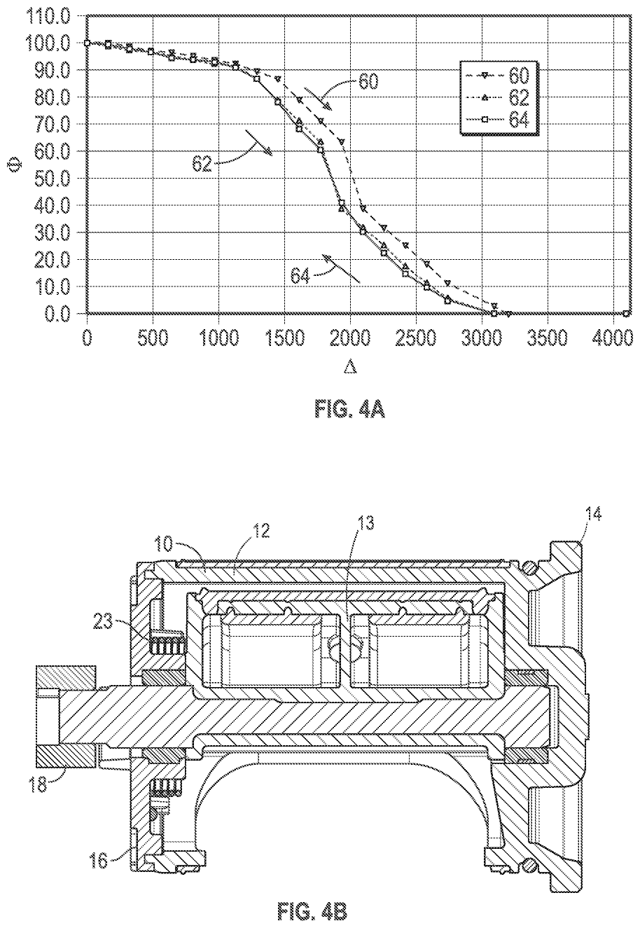

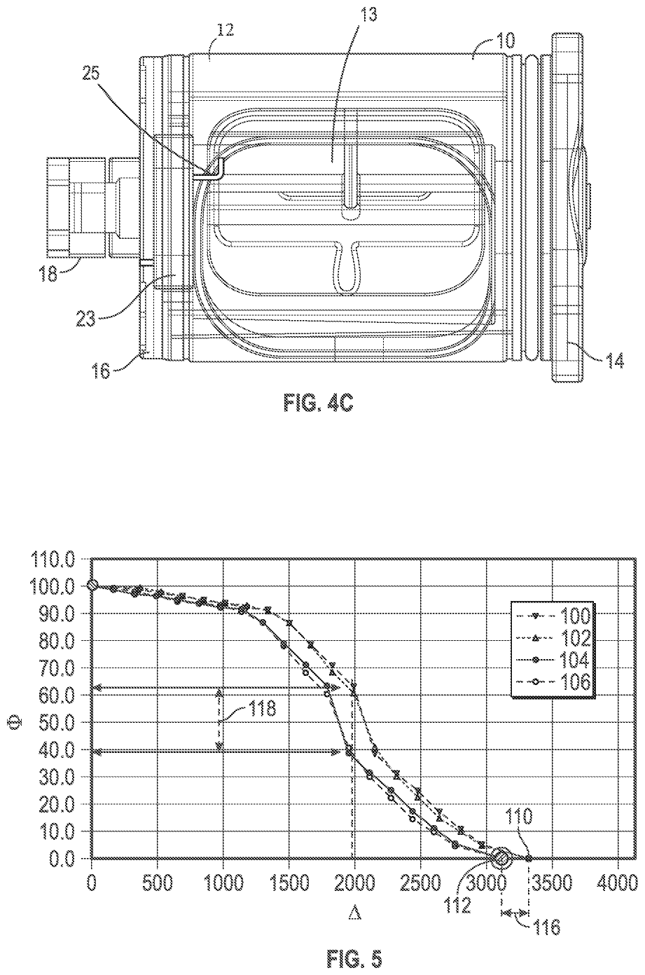

Referring now to FIGS. 4B and 4C, there are shown interior views of the flow control valve 10. Specifically, a spring 23 is positioned between the actuator 13 and the second end plate 16. The spring 23 includes an end 25 that engages with the actuator 13 to provide a rotational biasing force to the actuator 13.

The graph shown in FIG. 4A illustrates the effects of the spring 23, namely, the percentage of coolant flow (ϕ) versus the position (Δ) of the actuator 13 with and without the spring 23. The plot 60 illustrates the coolant flow through the flow control valve 10 without the spring 23 as the actuator 13 moves from an open position (maximum flow) to a closed position (zero flow). The plot 62 illustrates the coolant flow through the flow control valve 10 with the spring 23 as the actuator 13 moves from an open position (maximum flow) to a closed position (zero flow). And the plot 64 illustrates the coolant flow through the flow control valve 10 with the spring 23 as the actuator 13 moves from a closed position (zero flow) to an open position (maximum flow). In general, the coolant flow through the flow control valve 10 with the spring 23 is less than that through the flow control valve without the spring. Further, the spring in the flow control valve 10 only has to recover the hysteresis between the opening and closing of the actuator 13. The spring 23 has a negligible effect on the current flow to DC motor 22 provided, for example, by an electronic control unit. The spring 23 is made of any suitable material that does not deteriorate when exposed to coolant. In various arrangements, the spring 23 is utilized in combination with the actuator 13 that is self-locking, that is, the actuator 13 self-locks, for example, with the use of a worm gear.

Turning now to FIG. 5, calibration effects of the flow control valve 10 are shown, namely, the percentage of coolant flow (ϕ) versus the position (Δ) of the actuator 13 with and without calibration. The plot 100 illustrates the coolant flow through the flow control valve 10 without calibration as the actuator 13 moves from an open position (maximum flow) to a closed position (zero flow). The plot 102 illustrates the coolant flow through the flow control valve 10 without calibration as the actuator 13 moves from a closed position (zero flow) to an open position (maximum flow). The plot 104 illustrates the coolant flow through the flow control valve 10 with calibration as the actuator 13 moves from an open position (maximum flow) to a closed position (zero flow). And the plot 106 illustrates the coolant flow through the flow control valve 10 with calibration as the actuator 13 moves from a closed position (zero flow) to an open position (maximum flow). As easily seen in the graph, there is a flow variation 118 of about 25% between the plots without calibration and the plots with calibration. Specifically, at an actuator position of about 2000, the coolant flow without calibration is about 25% higher than the coolant flow with calibration. This difference can be attributed to the tolerances or part to part variations during fabrication of the flow control valves.

According to the principles of the present disclosure, the calibration process provides that the coolant flow at the start of the coolant flow coincides the coolant flow at the end of the coolant flow. That is, the calibration process shifts the zero flow point 110 an amount 116 to the zero flow point 112 to eliminate the part to part variations 118.

Note, in the claims and specification, certain elements are designated as “first” and “second”. These are arbitrary designations intended to be consistent only in the section in which they appear, that is, the specification or the claims or the summary, and are not necessarily consistent between the specification, the claims, and the summary. In that sense they are not intended to limit the elements in any way and a “second” element labeled as such in the claim may or may not refer to a “second” element labeled as such in the specification. Instead, the elements are distinguishable by their disposition, description, connections, and function.

A flow control valve for a motor vehicle coolant system of the present disclosure offers several advantages. These include, for example, the ability to reduce the coolant flow to the minimum flow required to maintain the optimum combustion chamber temperature while prevent boiling of the coolant flow in the coolant circuit. As such, thermodynamic efficiency is increased and frictional losses are reduced.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A flow control valve for coolant flow in a motor vehicle, the flow control valve comprising:
a stationary body with an inlet and an outlet;
a first base plate positioned on a first end of the stationary body; and
a second base plate positioned on a second end of the stationary body,
wherein the outlet has a main opening and a secondary opening to control the coolant flow.

2. The flow control valve of claim 1, wherein the main opening and the secondary opening define a T-shaped opening.

3. The flow control valve of claim 1, wherein the secondary opening is a U-shaped opening.

4. The flow control valve of claim 1, wherein the coolant flow with the secondary opening is more than the coolant flow without the secondary opening.

5. (canceled)

6. The flow control valve of claim 1, wherein the flow control valve is coupled to a DC motor through a set of gears.

7. (canceled)

8. The flow control valve of claim 1, wherein the flow control valve is calibrated such that an open-to-close profile ends with a zero flow point and a close-to-open profile begins with the same zero flow point.

9. (canceled)

10. A flow control valve for coolant flow in a motor vehicle, the flow control valve comprising:
a stationary body with an inlet and an outlet;
a first base plate positioned on a first end of the stationary body; and
a second base plate positioned on a second end of the stationary body,
wherein the outlet has a main opening and a secondary opening to control the coolant flow, the main opening and the secondary opening defining a T-shaped opening, the secondary opening being a U-shaped opening.

11. The flow control valve of claim 10, wherein the coolant flow with the secondary opening is more than the coolant flow without the secondary opening.

12. (canceled)

13. The flow control valve of claim 10, wherein the flow control valve is coupled to a DC motor through a set of gears.

14. (canceled)

15. The flow control valve of claim 10, wherein the flow control valve is calibrated such that an open-to-close profile ends with a zero flow point and a close-to-open profile begins with the same zero flow point.

16-20. (canceled)
